(19) United States
(12) Patent Application Publication
(10) Pub. No.: US 2018/0095521 A1
(43) Pub. Date: Apr. 5, 2018

(54) RETENTION MODE OPERATION FOR REDUCED STANDBY CONSUMPTION IN TOUCH SOLUTIONS

(71) Applicant: SYNAPTICS INCORPORATED, San Jose, CA (US)

(72) Inventors: Aswani TADINADA, Hyderabad (IN); Timothy L. BLANKENSHIP, Austin, TX (US); Prashant SHAMARAO, Cupertino, CA (US); Kaushalendra TRIPATHI, Pleasanton, CA (US); Sivan Kumar PANDIAN, Hyderabad (IN)

(21) Appl. No.: 15/283,224

(22) Filed: Sep. 30, 2016

(51) Int. Cl. G06F 1/32; G06F 3/044; G06F 3/041

(52) U.S. Cl. CPC G06F 1/3296; G06F 1/3262; G06F 2203/04108; G06F 3/0416; G06F 3/044

(57) ABSTRACT

Embodiments described herein include a method for reducing power consumption in a capacitive touch sensor. The method includes driving the capacitive touch sensor with an operating voltage at a first voltage level. The method also includes entering the capacitive touch sensor into a sleep mode responsive to a lack of touch input to the capacitive touch sensor. The method includes reducing the operating voltage to a second voltage level, and driving the capacitive touch sensor with the operating voltage at the second voltage level.

### BACKGROUND

### Field of the Disclosure

Embodiments of the present invention generally relate to a method and apparatus for touch sensing, and more specifically, to a power saving mode.

### Description of the Related Art

Input devices including proximity sensor devices (also commonly called touchpads or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones).

### SUMMARY

Embodiments described herein include a method for reducing power consumption in a capacitive touch sensor. The method includes driving the capacitive touch sensor with an operating voltage at a first voltage level. The method also includes entering the capacitive touch sensor into a sleep mode responsive to a lack of touch input to the capacitive touch sensor. The method includes reducing the operating voltage to a second voltage level, and driving the capacitive touch sensor with the operating voltage at the second voltage level.

In another embodiment, a processing system for capacitive touch sensing comprises a voltage regulator configured to drive a processor, a memory, and a capacitive touch sensor with a first supply voltage of a capacitive sensing device. The voltage regulator is also configured to, in response to the capacitive touch sensor entering a sleep mode, drive the processor, the memory, and the capacitive touch sensor with a second supply voltage less than the first supply voltage, where data stored in the memory is retained at the second supply voltage.

In another embodiment, an input device for capacitive touch sensing comprises a capacitive touch sensor, a processor, a memory, and a processing system. The processing system is configured to drive the processor, the memory, and the capacitive touch sensor at a first voltage level. In response to a lack of touch input to the capacitive touch sensor, the processing system is further configured to drive the processor, the memory, and the capacitive touch sensor at a second voltage level less than the first voltage level, where data stored in the memory is retained at the second voltage level.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a system that includes an input device according to an embodiment.

FIG. 2 is an example sensor electrode pattern according to an embodiment.

FIG. 3 illustrates a capacitive touch sensing device according to an embodiment.

FIG. 4 is a flow diagram illustrating a method for reducing power consumption in a capacitive touch sensing device in accordance with an embodiment.

FIG. 5 is a flow diagram illustrating another method for reducing power consumption in a capacitive touch sensing device in accordance with an embodiment.

To facilitate understanding, identical reference numerals have been used, where possible, to designate identical elements that are common to the figures. It is contemplated that elements disclosed in one embodiment may be beneficially utilized on other embodiments without specific recitation. The drawings referred to here should not be understood as being drawn to scale unless specifically noted. Also, the drawings are often simplified and details or components omitted for clarity of presentation and explanation. The drawings and discussion serve to explain principles discussed below, where like designations denote like elements.

### DETAILED DESCRIPTION

The following detailed description is merely exemplary in nature and is not intended to limit the embodiments or the application and uses of such embodiments. Furthermore, there is no intention to be bound by any expressed or implied theory presented in the preceding technical field, background, brief summary or the following detailed description.

Various embodiments of the present technology provide input devices and methods for improving usability. Particularly, embodiments described herein advantageously provide an improvised sleep mode in which a core supply voltage that provides supply for a processor, memories, digital logic, caches, etc., is lowered from its nominal operating voltage to a lower voltage to reduce the static leakage currents. Compared to conventional sleep modes, this mode offers significantly lower sleep mode currents, particularly in smaller geometry processes (such as 55 nm processes). In addition, the supply voltage remains above a data retention voltage of the memory, so that data stored in the memory is not lost when entering and exiting the sleep mode.

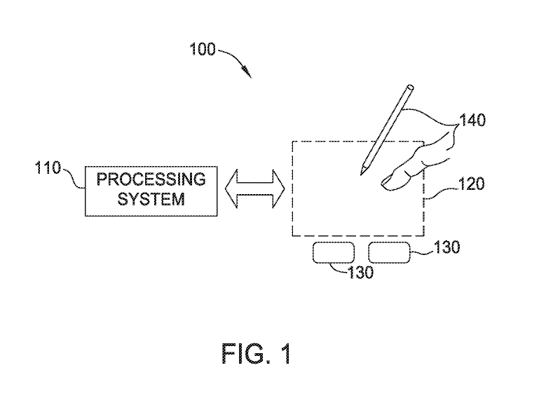

Turning now to the figures, FIG. 1 is a block diagram of an exemplary input device 100, in accordance with embodiments of the invention. The input device 100 may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device 100 and separate joysticks or key switches. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device 100.

The input device 100 can be implemented as a physical part of the electronic system or can be physically separate from the electronic system. As appropriate, the input device 100 may communicate with parts of the electronic system using any one or more of the following: buses, networks, and other wired or wireless interconnections. Examples include I²C, SPI, PS/2, Universal Serial Bus (USB), Bluetooth, RF, and IRDA.

In FIG. 1, the input device 100 is shown as a proximity sensor device (also often referred to as a “touchpad” or a “touch sensor device”) configured to sense input provided by one or more input objects 140 in a sensing region 120. Example input objects 140 include fingers and styli, as shown in FIG. 1.

Sensing region 120 encompasses any space above, around, in, and/or near the input device 100 in which the input device 100 is able to detect user input (e.g., user input provided by one or more input objects 140). The sizes, shapes, and locations of particular sensing regions 120 may vary widely from embodiment to embodiment. In some embodiments, the sensing region 120 extends from a surface of the input device 100 in one or more directions into space until signal-to-noise ratios prevent sufficiently accurate object detection. The distance to which this sensing region 120 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 100, contact with an input surface (e.g., a touch surface) of the input device 100, contact with an input surface of the input device 100 coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region 120 has a rectangular shape when projected onto an input surface of the input device 100.

The input device 100 may utilize any combination of sensor components and sensing technologies to detect user input in the sensing region 120. The input device 100 comprises one or more sensing elements for detecting user input. As several non-limiting examples, the input device 100 may use capacitive, elastive, resistive, inductive, magnetic, acoustic, ultrasonic, and/or optical techniques. Some implementations are configured to provide images that span one, two, three, or higher dimensional spaces. Some implementations are configured to provide projections of input along particular axes or planes. In some resistive implementations of the input device 100, a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device 100, one or more sensing elements pick up loop currents induced by a resonating coil or pair of coils. Some combination of the magnitude, phase, and frequency of the currents may then be used to determine positional information.

In some capacitive implementations of the input device 100, voltage or current is applied to create an electric field. Nearby input objects 140 cause changes in the electric field and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be uniformly resistive.

Some capacitive implementations utilize “self capacitance” (or “absolute capacitance”) sensing methods based on changes in the capacitive coupling between sensor electrodes and an input object 140. In various embodiments, an input object 140 near the sensor electrodes alters the electric field near the sensor electrodes, changing the measured capacitive coupling. In one implementation, an absolute capacitance sensing method operates by modulating sensor electrodes with respect to a reference voltage (e.g., system ground) and by detecting the capacitive coupling between the sensor electrodes and input objects 140.

Some capacitive implementations utilize “mutual capacitance” (or “transcapacitance”) sensing methods based on changes in the capacitive coupling between sensor electrodes. In various embodiments, an input object 140 near the sensor electrodes alters the electric field between the sensor electrodes, changing the measured capacitive coupling. In one implementation, a transcapacitive sensing method operates by detecting the capacitive coupling between one or more transmitter sensor electrodes (also “transmitter electrodes” or “transmitters”) and one or more receiver sensor electrodes (also “receiver electrodes” or “receivers”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. A resulting signal may comprise effect(s) corresponding to one or more transmitter signals and/or to one or more sources of environmental interference (e.g., other electromagnetic signals). Sensor electrodes may be dedicated transmitters or receivers, or sensor electrodes may be configured to both transmit and receive. Alternatively, the receiver electrodes may be modulated relative to ground.

In FIG. 1, a processing system 110 is shown as part of the input device 100. The processing system 110 is configured to operate the hardware of the input device 100 to detect input in the sensing region 120. The processing system 110 comprises parts of, or all of, one or more integrated circuits (ICs) and/or other circuitry components. For example, a processing system for a mutual capacitance sensor device may comprise transmitter circuitry configured to transmit signals with transmitter sensor electrodes and/or receiver circuitry configured to receive signals with receiver sensor electrodes. In some embodiments, the processing system 110 also comprises electronically-readable instructions, such as firmware code, software code, and/or the like. In some embodiments, components composing the processing system 110 are located together, such as near sensing element(s) of the input device 100. In other embodiments, components of processing system 110 are physically separate with one or more components close to sensing element(s) of input device 100 and one or more components elsewhere. For example, the input device 100 may be a peripheral coupled to a desktop computer, and the processing system 110 may comprise software configured to run on a central processing unit of the desktop computer and one or more ICs (perhaps with associated firmware) separate from the central processing unit. As another example, the input device 100 may be physically integrated in a phone, and the processing system 110 may comprise circuits and firmware that are part of a main processor of the phone. In some embodiments, the processing system 110 is dedicated to implementing the input device 100. In other embodiments, the processing system 110 also performs other functions, such as operating display screens, driving haptic actuators, etc.

The processing system 110 may be implemented as a set of modules that handle different functions of the processing system 110. Each module may comprise circuitry that is a part of the processing system 110, firmware, software, or a combination thereof. In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensing element(s) to detect input, identification modules configured to identify gestures such as mode changing gestures, and mode changing modules for changing operation modes.

In some embodiments, the processing system 110 responds to user input (or lack of user input) in the sensing region 120 directly by causing one or more actions. Example actions include changing operation modes, as well as GUI actions such as cursor movement, selection, menu navigation, and other functions. In some embodiments, the processing system 110 provides information about the input (or lack of input) to some part of the electronic system (e.g., to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions.

For example, in some embodiments, the processing system 110 operates the sensing element(s) of the input device 100 to produce electrical signals indicative of input (or lack of input) in the sensing region 120. The processing system 110 may perform any appropriate amount of processing on the electrical signals in producing the information provided to the electronic system. For example, the processing system 110 may digitize analog electrical signals obtained from the sensor electrodes. As another example, the processing system 110 may perform filtering or other signal conditioning. As yet another example, the processing system 110 may subtract or otherwise account for a baseline, such that the information reflects a difference between the electrical signals and the baseline. As yet further examples, the processing system 110 may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device 100 is implemented with additional input components that are operated by the processing system 110 or by some other processing system. These additional input components may provide redundant functionality for input in the sensing region 120 or some other functionality. FIG. 1 shows buttons 130 near the sensing region 120 that can be used to facilitate selection of items using the input device 100. Other types of additional input components include sliders, balls, wheels, switches, and the like. Conversely, in some embodiments, the input device 100 may be implemented with no other input components.

In some embodiments, the input device 100 comprises a touch screen interface, and the sensing region 120 overlaps at least part of an active area of a display screen. For example, the input device 100 may comprise substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device 100 and the display screen may share physical elements. For example, some embodiments may utilize some of the same electrical components for displaying and sensing. As another example, the display screen may be operated in part or in total by the processing system 110.

It should be understood that while many embodiments of the invention are described in the context of a fully functioning apparatus, the mechanisms of the present invention are capable of being distributed as a program product (e.g., software) in a variety of forms. For example, the mechanisms of the present invention may be implemented and distributed as a software program on information bearing media that are readable by electronic processors (e.g., non-transitory computer-readable and/or recordable/writable information bearing media readable by the processing system 110). Additionally, the embodiments of the present invention apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

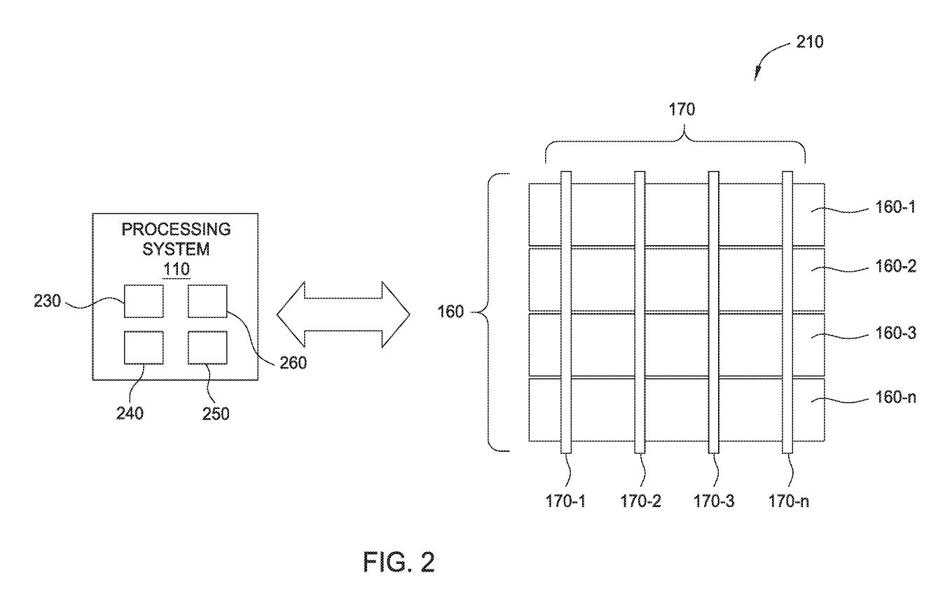

FIG. 2 illustrates a system 210 including a processing system 110 and a portion of an example sensor electrode pattern configured to sense in a sensing region 120 associated with the pattern, according to some embodiments. For clarity of illustration and description, FIG. 2 shows a pattern of simple rectangles illustrating sensor electrodes, and does not show various components. This sensor electrode pattern comprises a plurality of transmitter electrodes 160 (160-1, 160-2, 160-3, . . . 160-n), and a plurality of receiver electrodes 170 (170-1, 170-2, 170-3, . . . 170-n) disposed over the plurality of transmitter electrodes 160.

Transmitter electrodes 160 and receiver electrodes 170 are typically ohmically isolated from each other. That is, one or more insulators separate transmitter electrodes 160 and receiver electrodes 170 and prevent them from electrically shorting to each other. In some embodiments, transmitter electrodes 160 and receiver electrodes 170 are separated by insulative material disposed between them at cross-over areas; in such constructions, the transmitter electrodes 160 and/or receiver electrodes 170 may be formed with jumpers connecting different portions of the same electrode. In some embodiments, transmitter electrodes 160 and receiver electrodes 170 are separated by one or more layers of insulative material. In some other embodiments, transmitter electrodes 160 and receiver electrodes 170 are separated by one or more substrates; for example, they may be disposed on opposite sides of the same substrate, or on different substrates that are laminated together.

The areas of localized capacitive coupling between transmitter electrodes 160 and receiver electrodes 170 may be termed “capacitive pixels.” The capacitive coupling between the transmitter electrodes 160 and receiver electrodes 170 change with the proximity and motion of input objects 140 in the sensing region associated with the transmitter electrodes 160 and receiver electrodes 170.

In some embodiments, the sensor pattern is “scanned” to determine these capacitive couplings. That is, the transmitter electrodes 160 are driven to transmit transmitter signals. Transmitters may be operated such that one transmitter electrode 160 transmits at one time, or multiple transmitter electrodes 160 transmit at the same time. Where multiple transmitter electrodes 160 transmit simultaneously, these multiple transmitter electrodes 160 may transmit the same transmitter signal and effectively produce an effectively larger transmitter electrode 160, or these multiple transmitter electrodes 160 may transmit different transmitter signals. For example, multiple transmitter electrodes 160 may transmit different transmitter signals according to one or more coding schemes that enable their combined effects on the resulting signals of receiver electrodes 170 to be independently determined.

The receiver sensor electrodes 170 may be operated singly or multiply to acquire resulting signals. The resulting signals may be used to determine measurements of the capacitive couplings at the capacitive pixels.

A set of measurements from the capacitive pixels form a “capacitive image” (also “capacitive frame”) representative of the capacitive couplings at the pixels. Multiple capacitive images may be acquired over multiple time periods, and differences between them used to derive information about input in the sensing region 120. For example, successive capacitive images acquired over successive periods of time can be used to track the motion(s) of one or more input objects 140 entering, exiting, and within the sensing region.

The background capacitance of a sensor device 100 is the capacitive image associated with no input object 140 in the sensing region 120. The background capacitance changes with the environment and operating conditions, and may be estimated in various ways. For example, some embodiments take “baseline images” when no input object 140 is determined to be in the sensing region 120, and use those baseline images as estimates of their background capacitances.

Capacitive images can be adjusted for the background capacitance of the sensor device 100 for more efficient processing. Some embodiments accomplish this by “baselining” measurements of the capacitive couplings at the capacitive pixels to produce a “baselined capacitive image.” That is, some embodiments compare the measurements forming a capacitance image with appropriate “baseline values” of a “baseline image” associated with those pixels, and determine changes from that baseline image.

In some touch screen embodiments, transmitter electrodes 160 comprise one or more common electrodes (e.g., “V-corn electrode”) used in updating the display of the display screen. These common electrodes may be disposed on an appropriate display screen substrate. For example, the common electrodes may be disposed on the TFT glass in some display screens (e.g., In Plane Switching (IPS) or Plane to Line Switching (PLS)), on the bottom of the color filter glass of some display screens (e.g., Patterned Vertical Alignment (PVA) or Multi-domain Vertical Alignment (MVA)), etc. In such embodiments, the common electrode can also be referred to as a “combination electrode”, since it performs multiple functions. In various embodiments, each transmitter electrode 160 comprises one or more common electrodes. In other embodiments, at least two transmitter electrodes 160 may share at least one common electrode.

In various touch screen embodiments, the “capacitive frame rate” (the rate at which successive capacitive images are acquired) may be the same or be different from that of the “display frame rate” (the rate at which the display image is updated, including refreshing the screen to redisplay the same image). In some embodiments where the two rates differ, successive capacitive images are acquired at different display updating states, and the different display updating states may affect the capacitive images that are acquired. That is, display updating affects, in particular, the background capacitive image. Thus, if a first capacitive image is acquired when the display updating is at a first state, and a second capacitive image is acquired when the display updating is at a second state, the first and second capacitive images may differ due to differences in the background capacitive image associated with the display updating states, and not due to changes in the sensing region 120. This is more likely where the capacitive sensing and display updating electrodes are in close proximity to each other, or when they are shared (e.g., combination electrodes).

For convenience of explanation, a capacitive image that is taken during a particular display updating state is considered to be of a particular frame type. That is, a particular frame type is associated with a mapping of a particular capacitive sensing sequence with a particular display sequence. Thus, a first capacitive image taken during a first display updating state is considered to be of a first frame type, a second capacitive image taken during a second display updating state is considered to be of a second frame type, a third capacitive image taken during a first display updating state is considered to be of a third frame type, and so on. Where the relationship of display update state and capacitive image acquisition is periodic, capacitive images acquired cycle through the frame types and then repeats.

Processing system 110 may include a driver module 230, a receiver module 240, a determination module 250, and an optional memory 260. The processing system 110 is coupled to receiver electrodes 170 and transmitter electrodes 160 through a plurality of conductive routing traces (not shown in FIG. 2).

The receiver module 240 is coupled to the plurality of receiver electrodes 170 and configured to receive resulting signals indicative of input (or lack of input) in the sensing region 120 and/or of environmental interference. The receiver module 240 may also be configured to pass the resulting signals to the determination module 250 for determining the presence of an input object 140 and/or to the optional memory 260 for storage. In various embodiments, the IC of the processing system 110 may be coupled to drivers for driving the transmitter electrodes 160. The drivers may be fabricated using thin-film-transistors (TFT) and may comprise switches, combinatorial logic, multiplexers, and other selection and control logic.

The driver module 230, which includes driver circuitry, included in the processing system 110 may be configured for updating images on the display screen of a display device (not shown). For example, the driver circuitry may include display circuitry and/or sensor circuitry configured to apply one or more pixel voltages to the display pixel electrodes through pixel source drivers. The display and/or sensor circuitry may also be configured to apply one or more common drive voltages to the common electrodes to update the display screen. In addition, the processing system 110 is configured to operate the common electrodes as transmitter electrodes for input sensing by driving transmitter signals onto the common electrodes.

The processing system 110 may be implemented with one or more ICs to control the various components in the input device 100. For example, the functions of the IC of the processing system 110 may be implemented in more than one integrated circuit that can control the display module elements (e.g., common electrodes) and drive transmitter signals and/or receive resulting signals received from the array of sensing elements. In embodiments where there is more than one IC of the processing system 110, communications between separate processing system ICs 110 may be achieved through a synchronization mechanism, which sequences the signals provided to the transmitter electrodes 160. Alternatively the synchronization mechanism may be internal to any one of the ICs.

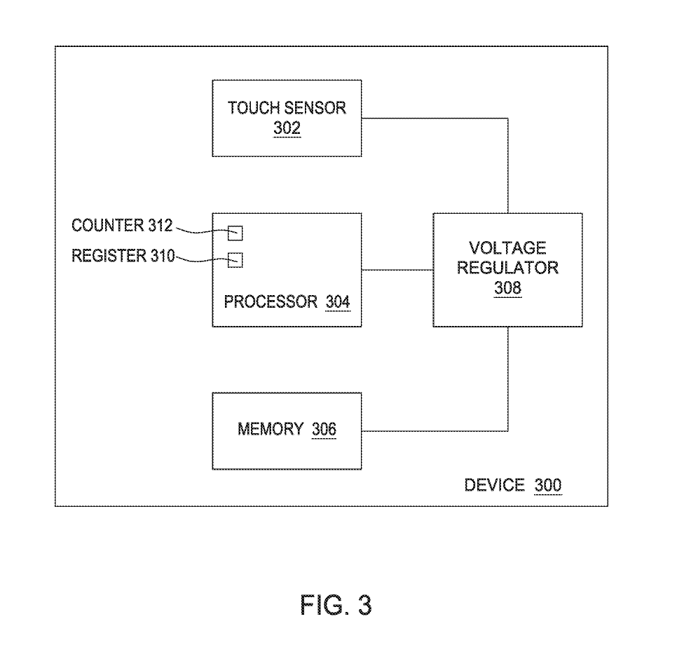

FIG. 3 illustrates an example block diagram of a capacitive touch sensing device 300 that provides an improved sleep mode for the device. The sleep mode is a low-power mode of operation that may be referred to as “retention mode.” In this sleep mode, data stored in the memory 306 is retained while the device 300 enters and exits sleep mode. In addition, static leakage currents are reduced in device 300 while in the sleep mode.

Device 300 comprises a capacitive touch sensor 302. Capacitive touch sensor 302 comprises a sensing region 120 as illustrated in FIG. 1. Device 300 further comprises a processor 304, memory 306, and voltage regulator 308. Processor 304 can comprise any type of circuitry configured to perform the functions described herein. Memory 306 comprises any suitable type of memory, such as SRAM (static random access memory) or cache memory. Voltage regulator 308 comprises circuitry configured to provide supply voltage to touch sensor 302, processor 304, and memory 306. Different supply voltages can be supplied to different components by voltage regulator 308. In addition, in embodiments described herein, the supply voltage supplied by voltage regulator 308 can be lowered to reduce static leakage currents in memory 306.

In a regular mode of operation for device 300, voltage regulator 308 provides a first supply voltage (also known as an operating voltage) to touch sensor 302, processor 304, and memory 306. In one embodiment, this first supply voltage level is about 1.2 V. Leakage currents in memory 306 and other components are a function of the supply voltage. When the device 300 enters a sleep mode, certain components can be turned off to minimize power dissipation to preserve battery life. However, the leakage currents still exist in sleep mode, and can consume a relatively large amount of power. Therefore, when processor 304 enters sleep mode, voltage regulator 308 can reduce the supply voltage to a second voltage level that is lower than the first supply voltage level, such as 0.88 V to 1.02 V in one example embodiment. The leakage currents at this voltage level are reduced compared to the leakage currents at a supply voltage of 1.2 V. Importantly, the second voltage level is also above the data retention voltage level of the SRAM of memory 306. Therefore, no data is lost in memory 306 or in data registers when the supply voltage level is lowered to the second supply voltage level and then recovered back to the first supply voltage level of about 1.2 V.

One of the predominant leakage currents is sub-threshold leakage. Sub-threshold leakage is the current between the source and drain of a FET (field-effect transistor) when the transistor is in a sub-threshold region (i.e., the gate-to-source voltage is below the threshold voltage). Sub-threshold leakage I_{off} is mathematically shown in the following equation:

$${I}_{off} = {I}_{O} ( 1 - {e}^{\frac{- {V}_{ds}}{{V}_{t}}} ) ( {e}^{\frac{{V}_{gs} - {V}_{TH}}{{V}_{t}}} )$$

where I_{O} is the leakage current, Vₜ is the thermal voltage, V_{ds} is the drain-to-source voltage, V_{gs} is the gate-to-source voltage, and V_{TH} is the threshold voltage of the device. In sleep mode, the transistors are off. Therefore, the gate-to-source voltage is zero. The equation then simplifies to:

$${I}_{off} = {I}_{O} ( 1 - {e}^{\frac{- {V}_{ds}}{{V}_{t}}} ) ( {e}^{\frac{- {V}_{TH}}{{V}_{t}}} )$$

The leakage current I_{O} is a function of temperature, voltage, and process variations. Reducing the supply voltage in sleep mode reduces the drain-to-source voltage V_{ds} and increases the threshold voltage V_{TH}. This reduces the sub-threshold leakage current I_{off}, resulting in less power consumed by the capacitive touch sensing device 300 while in the sleep mode.

The value of the supply voltage during the sleep mode can vary as described above. In one embodiment, when processor 304 enters the sleep mode, processor 304 notifies voltage regulator 308 that sleep mode is active and that voltage regulator 308 should lower the supply voltage from the first voltage level to a second voltage level. The second voltage level can be a preset, default value stored in a register at processor 304 (like register 310) or stored in another component of device 300, such as a register at voltage regulator 308. In some embodiments, the value of the second voltage level stored in register 310 can be adjustable. For example, a firmware update could change the value of the second voltage level stored in the register 310, and then the supply voltage would be lowered to the new value when processor 304 enters sleep mode. The value of the second voltage level can be read from register 310 to determine the proper value at which to set the second voltage level when processor 304 enters sleep mode.

The processor 304 can enter the sleep mode in a number of ways. In one embodiment, processor 304 is actively checking touch sensor 302 for a detected touch. If there is no touch or other input detected after a predetermined amount of time, processor 304 can enter the sleep mode. In the sleep mode, certain components can be shut down to reduce power consumption. In addition, the supply voltage can be lowered as described above to further reduce power consumption, particularly by reducing the leakage current in memory 306.

In another embodiment, the processor 304 can enter the sleep mode based on an action by a user. For example, a user may select an icon on a touchscreen to place the device 300 in sleep mode. Or, a user may press a button on the device 300, such as a power button, and the processor 304 responds by placing the device in sleep mode.

The processor 304 can also exit the sleep mode in a number of ways. In one example, a counter 312 in processor 304 may be used to periodically exit sleep mode. When the processor 304 enters sleep mode, counter 312 begins a countdown. Once the counter 312 reaches zero, processor 304 exits sleep mode and notifies voltage regulator 308 to raise the supply voltage. At that time, processor 304 can check touch sensor 302 to see if there is an active touch. If no active touch is detected, processor 304 can re-enter sleep mode and voltage regulator 308 can again lower the supply voltage. Counter 312 can then begin another countdown.

Another method for processor 304 to exit sleep mode is for the user to perform an action. For example, a user may press a button on device 300, and the processor 304 responds by exiting the sleep mode.

In some embodiments, an input object 140 can be detected with reduced spatial information while in sleep mode. For example, touch sensor 302 can continue to scan for an active touch or other input while in sleep mode. However, touch sensor 302 may scan less frequently for the active touch than the frequency of scanning in the normal operating mode. Touch sensor 302 may scan for an active touch or other input at a first frequency while in the normal operating mode, and then scan at a lower second frequency while in the sleep mode.

In another embodiment, touch sensor 302 may only detect presence of an active touch or other input while in the sleep mode. Once the active touch or other input is detected, processor 304 can exit sleep mode and additional scanning can be performed by touch sensor 302 to detect a location of the active touch or other input. Detecting the active touch with reduced spatial information while in the sleep mode can also contribute to reduced power consumption while device 300 is in sleep mode.

In some embodiments, processor 304 may enter sleep mode responsive to the touch sensor 302 failing to detect an input object 140 for a duration of time in normal operating mode. While in sleep mode, the touch sensor 302 may continue to attempt to detect input objects 140 with reduced spatial resolution and/or reduced frequency of touch sensing. Responsive to the touch sensor 302 detecting an input object 140 in sleep mode, the processor 304 may return to normal operating mode. In other embodiments, a verification mode may be entered as an intermediate step when going from sleep mode to normal operating mode. For example, the processor 304 may return the operating voltage to that of the normal operating mode and perform further analysis on the input object 140 causing the exit from sleep mode. If the input object 140 appears to be an intended touch, the system proceeds to normal operating mode. However, if the input object 140 does not appear to be an intended touch based on additional information available through increased spatial resolution or scanning frequency, the system may return to sleep mode after that determination has been made rather than waiting for the duration of time to pass without detecting an input object 140. An example of this may be detecting a large input object 140 such as a palm in sleep mode. Touch sensor 302 may be unable to identify the large input object 140 as a palm, and as a touch that does not warrant return to normal operating mode, at the reduced sensing capacity of sleep mode.

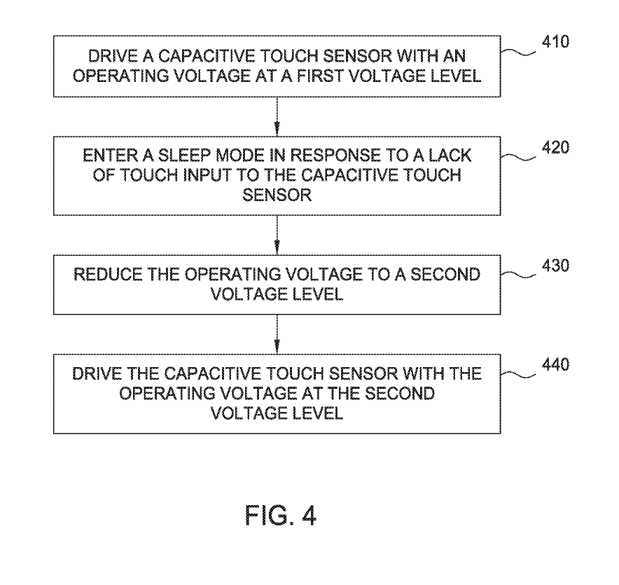

FIG. 4 is a flow diagram illustrating a method 400 for reducing power consumption in a capacitive touch sensing device 300 in accordance with one embodiment of the invention. Although the method steps are described in conjunction with FIGS. 1-3, persons skilled in the art will understand that any system configured to perform the method steps, in any feasible order, falls within the scope of the present invention. In various embodiments, the hardware and/or software elements described in FIGS. 1-3 can be configured to perform the method steps of FIG. 4.

The method 400 begins at step 410, where a voltage regulator such as voltage regulator 308 drives the capacitive touch sensor 302 with an operating voltage at a first voltage level. Driving the capacitive touch sensor 302 at the first voltage level is the normal operating mode of the capacitive touch sensing device.

The method 400 proceeds to step 420, where the capacitive touch sensor 302 enters into a sleep mode responsive to a lack of touch input to the capacitive touch sensor 302. In one embodiment, if there is no touch input after a predetermined amount of time, a processor 304 can enter the capacitive touch sensor 302 into the sleep mode.

At step 430, a voltage regulator 308 reduces the operating voltage to a second voltage level. Reducing the operating voltage to a second voltage level that is lower than the first voltage level reduces the standby leakage currents in memory 306. In addition, the second voltage level is above the data retention voltage level of memory 306, so any data stored in memory 306 is retained while entering and exiting sleep mode.

The method 400 proceeds to step 440, where voltage regulator 308 drives the capacitive touch sensor 302 with the operating voltage at the second voltage level. In some embodiments, capacitive touch sensor 302 can detect an active touch input or other input with reduced spatial information while being driven at the second voltage level (i.e., in sleep mode).

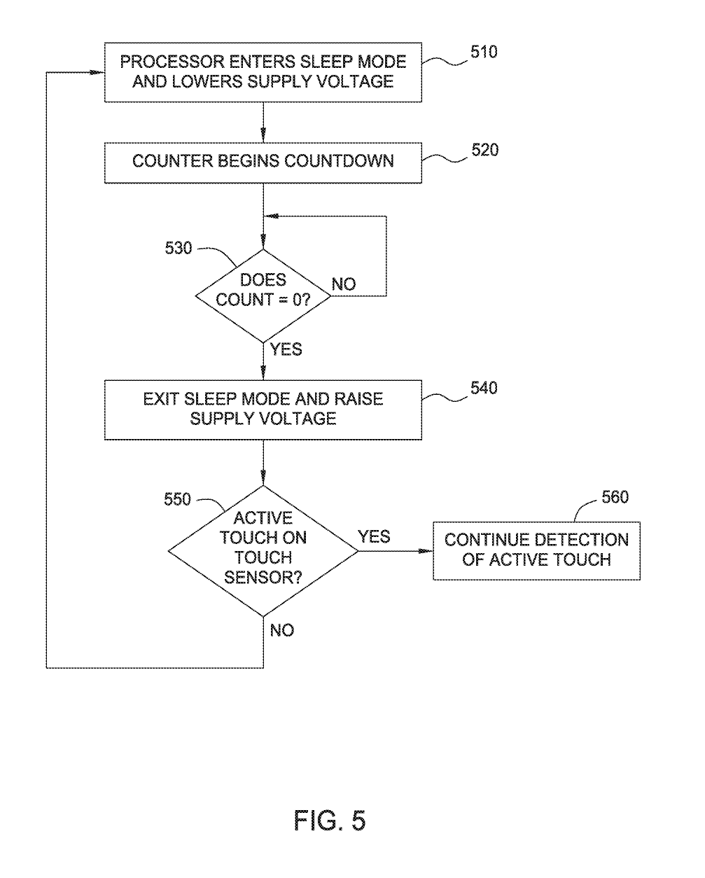

FIG. 5 is a flow diagram illustrating another method 500 for reducing power consumption in a capacitive touch sensing device in accordance with one embodiment of the invention. Although the method steps are described in conjunction with FIGS. 1-3, persons skilled in the art will understand that any system configured to perform the method steps, in any feasible order, falls within the scope of the present invention. In various embodiments, the hardware and/or software elements described in FIGS. 1-3 can be configured to perform the method steps of FIG. 5.

The method 500 begins at step 510, where the processor 304 enters a sleep mode and instructs voltage regulator 308 to reduce the operating voltage to the lower voltage level associated with the sleep mode. The processor 304 may enter sleep mode due to a lack of touch input to the capacitive touch sensor 302 for a predetermined amount of time.

The method 500 proceeds to step 520, where counter 312 begins a countdown. Counter 312 could be located in processor 304 or in any other suitable component of a capacitive touch sensing device. The duration of the countdown can comprise any suitable duration.

The method 500 proceeds to step 530, where processor 304 or another component checks the status of counter 312 to see if the countdown has reached zero. If the countdown has not reached zero, the counter 312 is checked again. If the counter 312 has reached zero, the method 500 proceeds to step 540.

At step 540, processor 304 exits sleep mode and instructs voltage regulator 308 to raise the supply voltage. The supply voltage is raised to the operating voltage associated with the normal operating mode (in one embodiment, 1.2 V). If other components of the capacitive touch sensing device were shut down during sleep mode, those components can be powered up in this step so that they are ready for touch detection. Once the supply voltage has been raised, the method 500 proceeds to step 550.

At step 550, processor 304 checks touch sensor 302 to determine if there is an active touch on touch sensor 302. If there is not an active touch, processor 304 can re-enter sleep mode. The method 500 therefore proceeds back to step 510, and another countdown can begin.

If there is an active touch on touch sensor 302 in step 550, the method 500 proceeds to step 560 where continued detection of the active touch occurs, if necessary, and operation of the capacitive touch sensing device 300 proceeds in the normal (non-sleep) operating mode. Operation in the normal operating mode will continue until processor 304 enters sleep mode again according to any of the methods for entering sleep mode described herein.

Thus, the embodiments and examples set forth herein were presented in order to best explain the embodiments in accordance with the present technology and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

In view of the foregoing, the scope of the present disclosure is determined by the claims that follow.

1. A method for reducing power consumption in a capacitive touch sensing device, comprising:
driving a capacitive touch sensor with an operating voltage at a first voltage level;
entering the capacitive touch sensor into a sleep mode responsive to a lack of touch input to the capacitive touch sensor;
reducing the operating voltage to a second voltage level; and
driving the capacitive touch sensor with the operating voltage at the second voltage level.

2. The method of claim 1, further comprising:
detecting an input object with the capacitive touch sensor operating at the second voltage level.

3. The method of claim 2, wherein detecting an input object with the capacitive touch sensor operating at the second voltage level comprises detecting the input object with reduced spatial information.

4. The method of claim 3, further comprising, after the input object is detected, exiting the sleep mode and raising the operating voltage to the first voltage level.

5. The method of claim 1, wherein the operating voltage further provides power to a processor and memory of the touch sensing device.

6. The method of claim 5, wherein data stored in the memory is retained at the second voltage level.

7. The method of claim 1, further comprising:
scanning for a touch input at a reduced frequency while the capacitive touch sensor is in the sleep mode.

8. An input device for capacitive touch sensing, comprising:
a capacitive touch sensor;
a processor;
a memory; and
a processing system configured to:
drive the processor, the memory, and the capacitive touch sensor at a first voltage level; and
in response to a lack of touch input to the capacitive touch sensor, drive the processor, the memory, and the capacitive touch sensor at a second voltage level less than the first voltage level, wherein data stored in the memory is retained at the second voltage level.

9. The input device of claim 8, wherein the processing system is further configured to detect an input object with the capacitive touch sensor operating at the second voltage level with reduced spatial information.

10. The input device of claim 8, wherein the processing system is further configured to, in response to a touch input to the capacitive touch sensor while driving the capacitive touch sensor at the second voltage level:
raise a supply voltage to the first voltage level; and
drive the processor, the memory, and the capacitive touch sensor at the first voltage level.

11. The input device of claim 10, wherein the processing system is further configured to determine a location of the touch input relative to the capacitive touch sensor.

12. The input device of claim 8, wherein the processing system is further configured to scan for the touch input to the capacitive touch sensor at a first frequency when the capacitive touch sensor is driven at the first voltage level and at a second frequency when the capacitive touch sensor is driven at the second voltage level.

13. The input device of claim 8, wherein standby leakage currents in the memory are lower when the memory is driven at the second voltage level than when the memory is driven at the first voltage level.

14. The input device of claim 8, wherein the second voltage level is stored in a register to be read by the processing system.

15. A processing system for capacitive touch sensing, comprising:
a voltage regulator configured to:
drive a processor, a memory, and a capacitive touch sensor with a first supply voltage of a capacitive sensing device; and
in response to the capacitive touch sensor entering a sleep mode, drive the processor, the memory, and the capacitive touch sensor with a second supply voltage less than the first supply voltage, wherein data stored in the memory is retained at the second supply voltage.

16. The processing system of claim 15, further comprising:
a determination module configured to detect a touch input in a sensing region of the capacitive touch sensor while the capacitive touch sensor is in the sleep mode.

17. The processing system of claim 15, wherein the capacitive touch sensor is configured to enter the sleep mode when no input object is in a sensing region of the capacitive touch sensor for a predetermined amount of time.

18. The processing system of claim 15, wherein the capacitive touch sensor is configured to enter the sleep mode responsive to detecting a touch input at an input device.

19. The processing system of claim 15, wherein the capacitive touch sensor is configured to exit the sleep mode after a predetermined amount of time to scan for an input to the capacitive touch sensor.

20. The processing system of claim 15, wherein the capacitive touch sensor is configured to exit the sleep mode responsive to a touch input at an input device.
